(19) United States
(12) Patent Application Publication
(10) Pub. No.: US 2012/0254859 A1
(43) Pub. Date: Oct. 4, 2012

(54) METHOD AND APPARATUS FOR DOWNLOADING SOFTWARE UPDATES TO PLACE USER TERMINAL INTO A DESIRED CONFIGURATION STATE

(75) Inventors: Jennifer DiCarlo, Fort Myers, FL (US); David Hofmann, Fort Myers, FL (US); Tam Dao, San Marcos, CA (US); Don Nguyen, Temecula, CA (US); Michael Joaquin, San Marcos, CA (US)

(73) Assignee: SONY CORPORATION, Tokyo (JP)

(21) Appl. No.: 13/077,513

(22) Filed: Mar. 31, 2011

(51) Int. Cl. G06F 9/445

(52) U.S. Cl. 717/178

(57) ABSTRACT

In accordance with the present invention, a method and apparatus that provides software products for installation on a user terminal is provided. The method begins by receiving over a communications network a user selection that includes a choice of a plurality of user-selected software products to be downloaded. In response to receipt of the user selection, an installation guide is assembled that includes installation instructions associated with each of the user-selected software products. A single user command is received over the communications network that includes a request to begin downloading the user-selected software products. In response to the request, the user-selected software products and the installation instructions are sequentially downloaded over the communications network to the user terminal. One or more of the software products may be configured to be automatically installed after they are downloaded.

### STATEMENT OF RELATED APPLICATIONS

This application is related to U.S. patent application Ser. No. 11/504,525, Aug. 14, 2006, entitled “Method and Apparatus for Downloading Software Updates”.

### FIELD OF INVENTION

The present invention relates generally to a user or client computer that downloads software updates from a remote server over a communications network, such as the Internet.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office file or records, but otherwise reserves all copyright rights whatsoever. The copyright owner does not hereby waive any of its rights to have this patent document maintained in secrecy, including without limitation its rights pursuant to 37 C.F.R. section 1.14.

### BACKGROUND

The continual and rapid development of computers, computer software, and related technology has revealed many problems with the typical distribution channels for computer software. For example, computer software, the coded instructions that control a computer's operation, are constantly and incrementally being upgraded and improved. The computer hardware and operating system environment on which the computer software is used is continually being changed, which requires additional changes in the computer software (e.g., new device drivers, new operating system calls, etc.).

A computer software developer will typically release an initial version of a software product. Thereafter, as new and improved computers and peripherals are developed, the software product will commonly be upgraded so as to take full advantage of the increased capabilities of the improved hardware. In addition, a software developer, to remain competitive, will often upgrade the software product to provide new features and functionality.

With the ever-increasing pace of advancement in computer related technologies, software developers compete to be the first to offer a new feature or upgrade. As a result, sometimes software products are made available to the public with unknown errors or defects. Similarly, software products that work as intended on a particular computer with a particular configuration may fail when installed on a different computer having a different configuration (e.g., different hardware, peripherals, operating systems, etc.). Software developers frequently provide fixes for their software products to correct defects that were undetected or unanticipated at the time the software product was released. Fixes are also provided to allow the software product to function correctly on a new computer or with a different operating system environment.

It is often difficult for software developers to make upgrades and fixes available to users. This difficulty not only deprives the user of access to the most reliable and up-to-date software products, it can result in lost sales to the software developer and can damage the goodwill and the development of a long term relationship with a customer by releasing a flawed or deficient software product.

Commonly, mass distribution of commercial software products is accomplished by copying the software product onto storage media (e.g., CD-ROMs, floppy disks, magnetic tapes, etc.). To take advantage of economies of scale, typically a large number of copies of the software product are made during the manufacture of a particular software product. Then, the storage media containing the software product is provided to distributors and retailers for sale to users. Given the rapid pace of software development, however, this manner of distribution is frequently insufficient. For example, it is not uncommon that defects are detected and fixes created shortly after a software product is introduced to the public. But the software products that remain in the distribution chain contain the defect without the fix. This situation is frustrating for users who subsequently purchase the software product that is already obsolete (i.e., because of the defects). Software can also be distributed over a communications network, such as the Internet and the like. In such distribution systems, a user connects to a remote site (e.g., an update server) and then selects and downloads desired software. Such systems allow for rapid updating of software by simply supplying a new, updated version of the software to the user. This updated software distribution scheme requires the user to select, download, and install the new software. The user may also need to obtain updated help files and other help utilities to assist the user in installing the updated software. This process is further complicated when the user wishes to download multiple software updates. Such a situation may arise, for example, when a manufacturer or vendor makes available a wide variety of electronic products that each may employ software that on occasion may be updated. For instance, a single manufacturer or vendor may offer a wide variety of consumer electronics, such as personal computers, personal digital assistants (PDAs), video cameras, digital cameras, MP3 players, and the like. After viewing the available software and selecting the software items that are desired, a user may be confronted with the need to download a relatively large number of software updates or other software products for multiple devices. The process of downloading and installing the new software can quickly become cumbersome and intimidating for a typical computer user when multiple software updates are required.

### SUMMARY OF THE INVENTION

In accordance with one aspect of the present invention, a method is provided that provides software products for installation on a user terminal. The method includes receiving over a communications network a user selection from among a plurality of options that each specify a configuration state in which the user terminal can be placed. The method also includes downloading the one or more software products over the communications network to the user terminal.

In accordance with another aspect of the present invention, a method provides software products to download for installation on a remote user terminal. The method includes receiving over a communications network a user selection from among a plurality of options that each specify a configuration state in which the user terminal can be placed. A current configuration state of the user terminal is discovered over the communications network. Based on the user selection and the current configuration state of the user terminal, one or more software products needed to place the user terminal into the specified configuration state is identified. The one or more software products are downloaded over the communications network to the user terminal.

### DESCRIPTION OF THE DRAWINGS

FIG. 1 is a block diagram of an illustrative high-level architecture of the operating environment in which the present invention may be employed.

FIG. 2 shows the update service computer and the user computer depicted in FIG. 1.

FIG. 3 is a flowchart showing one example of a process by which software updates may be downloaded in accordance with the present invention.

FIG. 4 is a flowchart showing another example of a process by which software updates may be downloaded in accordance with the present invention.

FIGS. 5-9 show illustrative user interface screens that are presented by one particular example of an update service application referred to as the Sony® Download Taxi™.

### DETAILED DESCRIPTION

The embodiments of the invention described herein are implemented as logical operations in a distributed processing system having client and server computing systems. It should be noted that the terms “server” and “client” may refer to either the software, the machine(s) on which the software is running, or a combination of both. The logical operations of the present invention are implemented (1) as a sequence of computer-implemented processes running on the computing system and (2) as interconnected machine modules within the computing system. The implementation is a matter of choice that is dependent on the performance requirements of the computing system implementing the invention. Accordingly, the logical operations making up the embodiments of the invention described herein are referred to variously as operations, steps, processes or modules.

The inventors have recognized that the process of updating one or more software products can be streamlined and made less cumbersome for the user, particularly when multiple software products are to be downloaded. The methods and modules described herein allow the user to download multiple software products using a single process that does not require the user to repetitively perform a sequence of steps to download each and every program file one after the other. Moreover, the user can pause the download process and resume it at a later, more convenient time. The user can also select from among a variety of languages in which to perform the download process. Among other things, instruction guides can be downloaded to the user in the user's choice of language. The instruction guide may be customized for the particular user by assembling the various installation instructions for each selected software product to be downloaded into a single composite instruction guide. The composite instruction guide can then be downloaded to the user in a single file, thereby avoiding the need for the user to separately download each individual instruction manual for each software product to be downloaded. The user can perform the process using any of a number of web browsers (including, for example, Internet Explorer™, Chrome, and Firefox™) and any of a number of different operating systems.

In some cases the user may be presented with a number of options regarding the types of software products that are available to the user for installation. These options can avoid the need for the user to search a database or web site for each and every software product they desire or need to install. Note that some software objects may require other software objects to be downloaded in order for them to be installed. For instance, the user may wish to install only updates to any software currently resident on an electronic device. Alternatively, the user may wish to return to a previous or original version of some software products resident on the electronic device such as drivers, operating system(s) and the like. In yet another alternative, the user may wish to replace an operating system with a new operating system. For instance, the user may currently be using Windows Vista and wishes to upgrade to Windows 7. The user may be presented with an option that allows him or her to select from each of these alternatives without manually searching for each individual file that is desired.

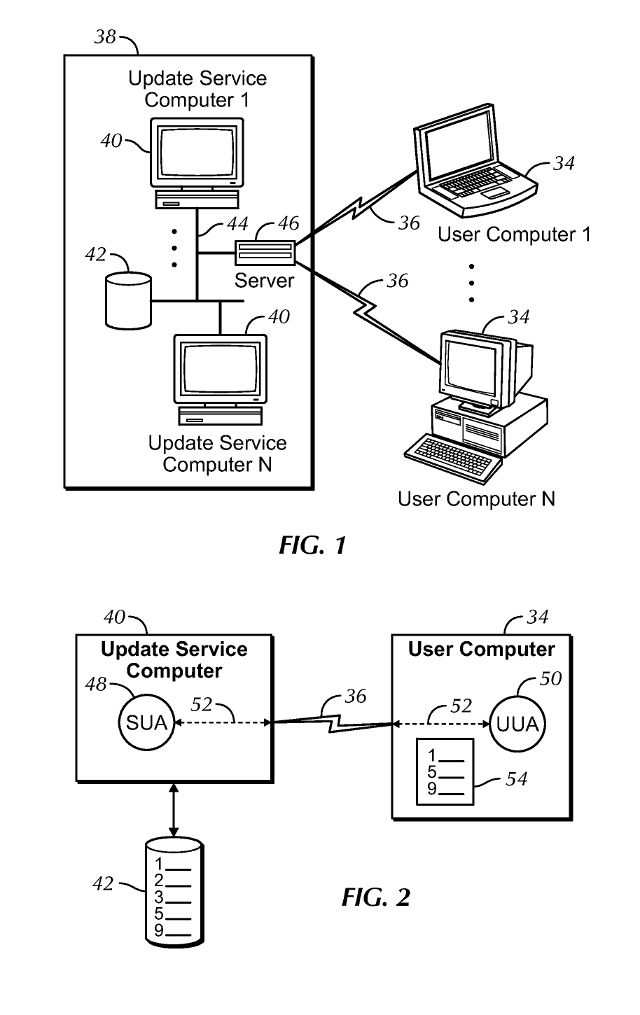

In order to perform some of the aforementioned tasks it may be helpful or necessary to provide the update service center with information regarding the particular electronics device for which the software is being obtained along with the software that is currently resident on that device. This can be accomplished using an autodiscovery process, thereby eliminating the need for the user to manually enter information concerning the current configuration of the electronic device. FIG. 1 is a block diagram of an illustrative high-level architecture of the operating environment in which the present invention may be employed. One or more user terminals or computers 34 are connected over communications links 36 to an update service center 38. The update service center 38 includes one or more computers 40 that are capable of simultaneous access by a plurality of user terminals or computers 34. If a plurality of update service computers 40 are used, then the update service computers may be connected by a local area network (LAN) 44 or any other similar connection technology. It is also possible for an update service center to have other configurations. For example, a smaller number of larger computers (i.e., a few mainframe, mini, etc. computers) with a number of internal programs or processes running on the larger computers capable of establishing communications links to the user computers. The update service center 38 may also be connected to a network (e.g., the Internet). The remote network or remote site allows the update service center 38 to provide a wider variety of computer software than could be stored at a single centralized update service center. That is, the software products are not necessarily all stored at a single location. In some cases the update service center 38 may be coupled via a network link to one or more other sites, remote from the service center 38. Software products can be stored on these other sites. If the user accesses the service center 38 for an update, the service center 38 in turn accesses the appropriate site at which the requested software is stored. The requested software is then transferred from that site via the service center 38 to the requesting user's computer 34.

One or more databases 42 connected to the update center computer(s) 40 are used to store database entries consisting of computer software available on the update service computer(s). The update service computer(s) 40 also contain a plurality of communication interfaces, such as telecommunications connections (e.g., modem connections, ISDN connections, ATM connection, frame relay connections, etc.), network connections (e.g. Internet, etc.), satellite connections (e.g. Digital Satellite Services, etc.), wireless connections, two way paging connections, etc., to allow one or more user computers 34 to simultaneously connect to the update service computer(s) 40. The interface connections are managed by an update server 46.

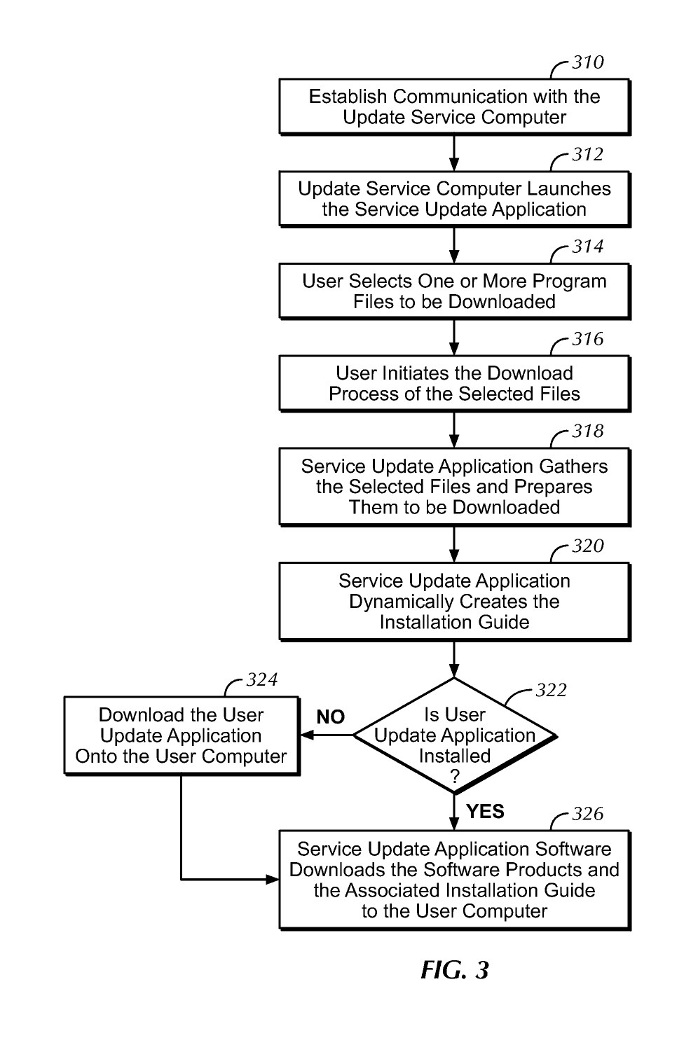

As shown in FIG. 2, running on the update service computer(s) 40 is one or more service update applications (SUA) 48 that communicate with a user update application (UUA) 50 on the user computer 34 when the update service is contacted by a user via user computer 34. The user update application 50 is a computer software program that is capable of initiating, establishing, and terminating two-way communications with an update service application on the update service computer. The service update application 48 is a computer software program which is also capable of initiating, establishing, and terminating two-way communications with a user update application on a user computer.

To access the update service center 38, a user starts UUA 50 on the user computer 34 (alternatively, the user can use a web browser to access the update service center 38 via its network address, e.g., URL). The user update application 50 tries to establish communication over two-way communications link 36 with an update service computer 40 using a modem, a network connection (e.g. Internet), etc. However, this access can also be completed by a variety of other methods which provide two-way data transfer. As the user update application 50 on the user computer 34 establishes communication with the update service computer 40, the update service computer 40 starts SUA 48. The service update application 48 then tries to establish a two-way communications link to the user update application 50 on the user computer. This is shown by the dashed lines 52 in FIG. 2. This communications link can be established with a network protocol stack, (e.g. TCP/IP) through sockets, or any other two-way communications technique known in the art. Once communication has been established, the service update application 48 allows the user to view, select, and download various software products. Once the software products are selected, the download and installation process is facilitated by the user update application 50 in the manner described below.

As shown in the flowchart of FIG. 3, at 310 a user begins the download process by establishing communication with the update service center 38. When the user makes the desired connection, the update service computer 40 launches the service update application 48 at 312. The service update application 48 presents the user with an interface (e.g., a web page) on the user computer 34 through which the user can select software that the user wishes to download and install. The user can select from a wide range of computer software products that are available for, e.g., various consumer electronics devices, such as personal computers (desktop, laptop, and the like), PDAs, video cameras, digital cameras, audio players (e.g., MP3-type), video players, televisions and the like. The software that is available may include, for example, new computer software, patches, fixes, drivers, new help files, wizards, operating system components, and updates, as well as enhancements and new features of existing computer software. The available software may also include entries describing new computer software (i.e., computer software that is not previously existing on the user computer 34). At 314 the user selects one or more program files to be downloaded. This step may require the user to browse through one or more list of available program files in order to make the desired selection or selections. Alternatively, as previously mentioned, in some implementations the user may be presented with a number of options regarding the types of software products that user wishes to install. These options each specify a configuration state in which the user computer can be placed, thereby avoiding the need for the user to search a database or web site for each and every software product they desire. For instance, one option may specify a configuration that allows the user to install only updates to any software currently resident on an electronic device. Alternatively, another option may specify a configuration state that returns the device to a previous configuration state in which previous or original versions of some software products resident on the electronic device such as drivers, operating system(s) and the like are reinstalled. In yet another alternative, another configuration state may specify a new operating system to which the user may migrate. For instance, the user currently may be using Windows Vista and wishes to upgrade to Windows 7. At 314, the user may be presented with an option that allows him or her to select from each of these alternative configuration states without manually searching for each individual file that is desired.

After making all the desired selections, the user initiates the download process of the selected files at 316, typically by activation or selection of a single icon presented by the update service center.

Next, at 318 the service update application 48 gathers the selected files and prepares them to be downloaded. In addition, the service update application 48 prepares an installation guide, which is a collection of installation instructions for the selected files. The service update application 48 dynamically creates the installation guide at 320 from various database entries and html installation files that may be located on any of the various service computers 40 or databases 42 associated with the update service center 38. The installation guide generally will be assembled in the language the user has selected to communicate in with the service update application 48. At 320 the service update application 48 queries the user if the user update application 50 is installed on the user computer 34. If at 322 the answer is no, the user is instructed to download the user update application 50 at 324. Finally, once the user update application is installed the service update application software 48 downloads the software products (e.g., executable program files) and the associated installation guide to the user computer 34 at 326.

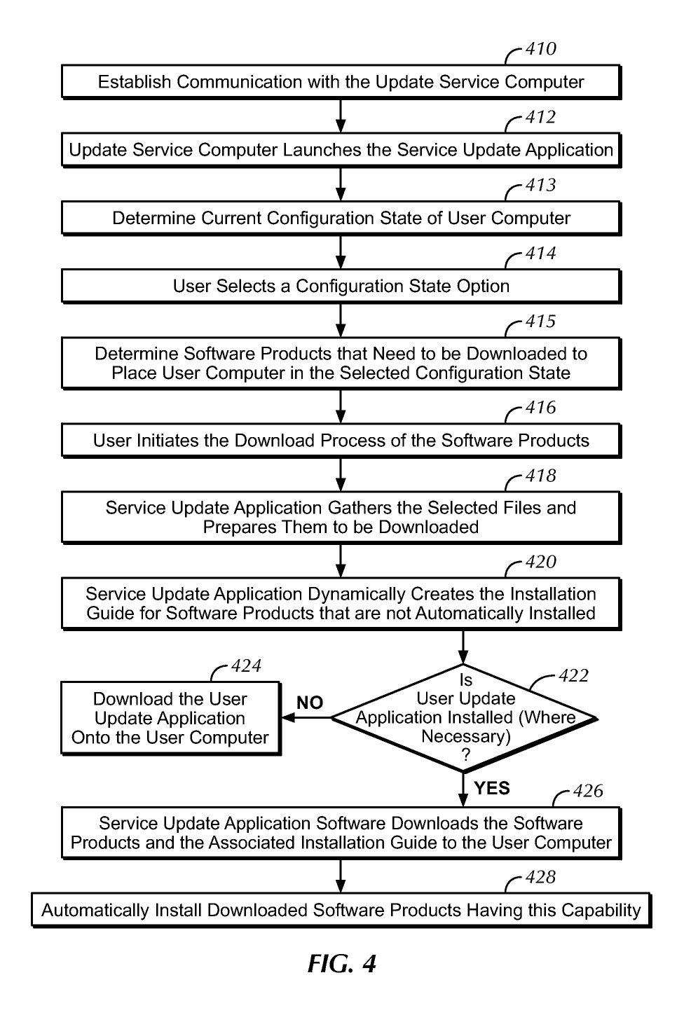

FIG. 4 shows an example of the download process when the software products are to be installed on the user computer 34 itself. Once again, at 410 a user establishes communication with the update service center 38 and in response the update service computer 40 launches the service update application 48 at 412. The service update application 48 presents the user with an interface (e.g., a web page) on the user computer 34 through which the user can select software that the user wishes to download and install.

In this example, at 413, the service update application begins an autodiscovery process to determine the current configuration state of the electronic device. The autodiscovery process determines the current hardware and software configuration state of the user computer 34. After the autodiscovery is complete, at 414 the user selects from among the various options that are presented to the user by the service update application 48. For instance, in this example the user selects an option to return the user computer 34 to a previous configuration state in which original drivers are restored. Of course, it should be noted that the user may also have the option to manually install individual files that they select.

An illustrative, non-exhaustive list of information that may be obtained about the configuration state of the user computer 34 may include some or all of the following: model identification. System Basic Input Output Software (BIOS) version. System F2 setup configuration (CMOS & related chips, random access memory (RAM) information (e.g., capacity, type, speed, number of chips, error correcting capability (ECC)), central processing unit (CPU) information, (e.g., vendor, model, & speed)). Video card information (e.g., vendor and BIOS/firmware version). Maximum vertical refresh rate of an attached monitor. Network Interface Card (NIC) detection. Small Computer Serial Interface (SCSI) controller information, such as vendor, model and firmware versions. Enhanced Integrated Drive Electronics (EIDE/IDE) controller information (e.g., current configuration). Peripheral Computer Interface (PCI) slot information, including the number of PCI slots and the types of devices in the slots. Intel Standard Architecture (ISA) slot information, including the number of ISA slots and the types of devices in the slots. Advanced Graphics Port (AGP) slot information, including the vendor, model, and firmware version of the card in the slot, number of physical disk drives, firmware version of each physical disk, capacity of each physical disk drive, number of partitions on each physical disk drive and so on.

After completing the autodiscovery process, the service update application at 415 determines the software products that the user computer needs in order to fulfill the user's request as specified by the option selected by the user at 413. Once the service update application indicates that it has obtained the requested software products, the user initiates the download process of the selected files at 416, typically by activation or selection of a single icon presented by the update service center.

Next, at 418 the service update application 48 gathers the selected files and prepares them to be downloaded. In addition, the service update application 48 may prepare the installation guide. At 420 the service update application 48 queries the user if the user update application 50 is installed on the user computer 34. If at 422 the answer is no, the user is instructed to download the user update application 50 at 424. In some cases the user would launch the update application directly from the web site. In this case the autodiscovery process of step 413 may be automatically initiated. Finally, once the user update application is installed (if necessary) the service update application software 48 downloads the software products (e.g., executable program files) and the associated installation guide to the user computer 34 at 426. For those software products that support it, the downloaded files may be automatically installed without any or only limited user intervention at 428. Installation guides may or may not be provided for those software products that are automatically installed.

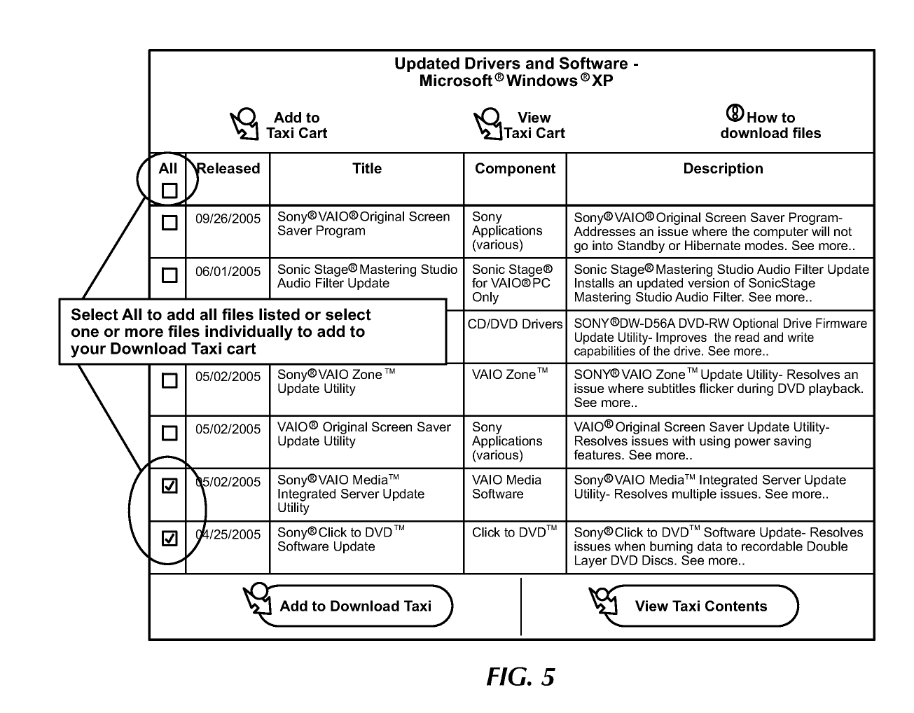

One particular example of an update service application that is currently used by consumers is the Sony® Download Taxi™. The Sony® Download Taxi™ is an update service application through which a consumer can download software updates for many different consumer electronic products such as those described above, including, for instance, personal computers, PDAs, video cameras, digital cameras, MP3 players and the like. The Sony® Download Taxi™ represents one example of a pre-existing update service application of the type described above in which the features, functionality and modules of the present invention may be employed. For purposes of illustration and not as a limitation on the invention additional features and functionality of the present invention will be shown in FIGS. 5-9 in connection with the Sony® Download Taxi™. Of course, the features, functionality, methods and modules of the present invention may be employed in connection with any appropriate update service application whether pre-existing or developed in the future.

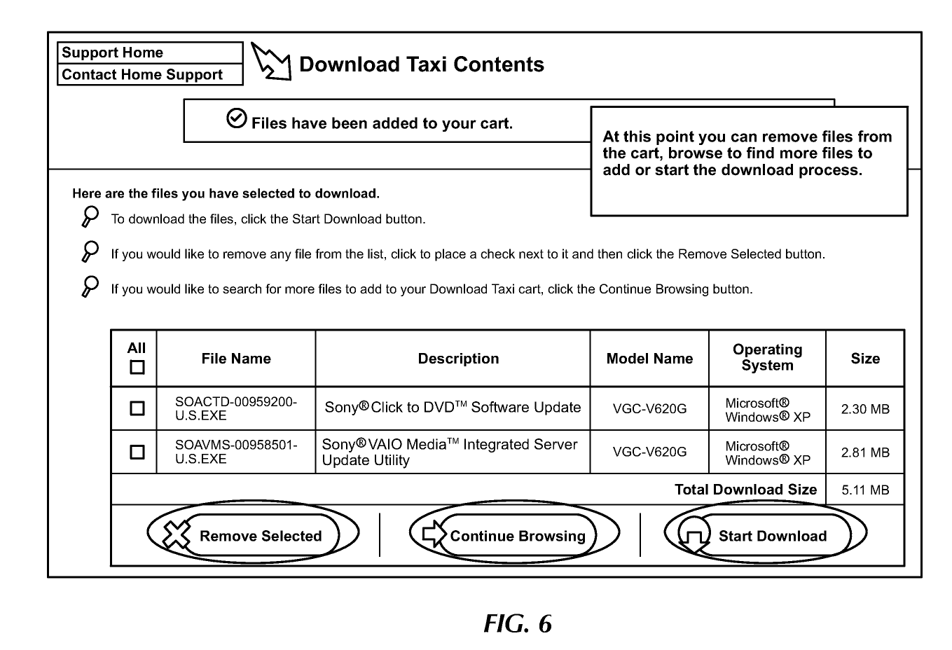

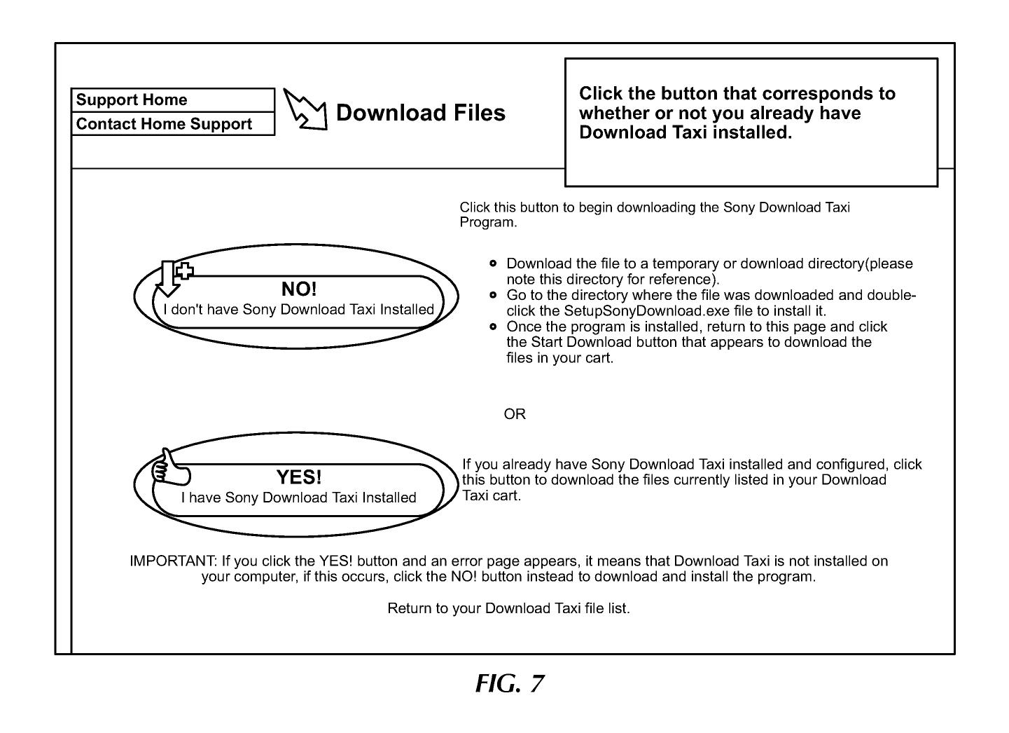

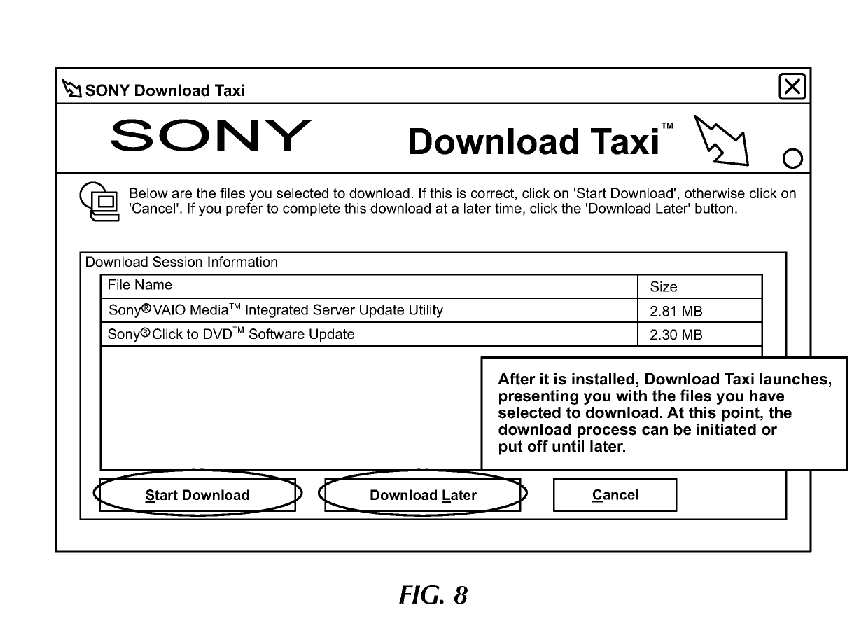

FIG. 5 shows an illustrative graphical user interface presented by the Sony® Download Taxi™ on the computer screen of the user computer 34. In this example the update service application interface uses a shopping cart metaphor. Via the interface, the user may browse through a wide selection of consumer electronic products available from Sony. In the interface depicted in FIG. 5, the user is presented with a number of software upgrades and drivers associated with the Microsoft® Windows™ or Apple Macintosh operating system. As shown, a release date, title and description of each software product is provided. The interface includes selectable icons that allow the user to individually choose from among the software products that are displayed. Another selectable icon is provided to allow the user to choose all the software products presented in that particular page of the interface. FIG. 6 is another interface screen that shows a list of the software products that have been selected by the user and moved to his or her shopping cart. All downloads selected by the user are stored in a session table, along with other session details, on the update service center 38. The list of selected files is associated with a unique session identification (ID). At this point the user is presented with a number of options that allows the user to remove selected software products, continue browsing for additional software products, or begin the download process. A selectable icon is provided for each of these options. In those implementations where the autodiscovery process is automatically performed when the use launches the application from the web site, the screen shown in FIG. 6 may be unnecessary since the presence of the application will be automatically discovered and, if necessary, installed without user intervention. FIG. 7 shows the interface screen that is presented to the user after choosing to begin the download process. The user is asked if the Sony® Download Taxi™ (i.e., the user update application) has been installed on their user computer. If not, the user is requested to install it at this point in the process.

FIG. 8 shows the interface screen of the Sony® Download Taxi™ when it is opened after beginning the download process with the service update application 50. The Download Taxi™ interface shows software products that have been selected for downloading. The user is presented with the options to begin the download process, to begin the download process at a later time, or to cancel the download process. A selectable icon is provided for each of these options.

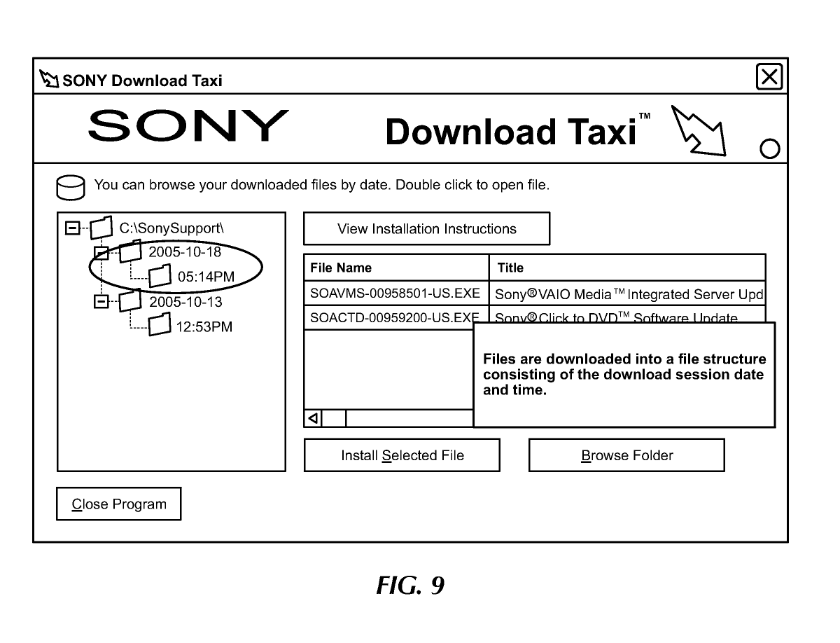

In FIG. 9 the interface screen of the Sony® Download Taxi™ is shown after the files have been downloaded into a common folder on the user's computer 34. The file structure consists of the download session date and time. In the particular example of FIG. 8 the software products are stored in the folder C:\Sony Support\YYYY-MM-DD, where YYYY-MM-DD signifies the date on which the download started. The Sony® Download Taxi™ stores the download details for a given download ID. on the user computer 34, thus preventing the loss of the download cart if the user's session is interrupted or otherwise lost. The Sony® Download Taxi™ records the state of the download in a file under the folder C:\Sony Support. The file includes the following details: session ID; a list of files and their associated update ID in the given download; the time when the download process started; the name of the file which is currently being downloaded; the number of bytes that have been downloaded for the current file; and a list of files that have already been downloaded during the session. Before a file is downloaded, the Sony® Download Taxi™ uses the Update ID to check the status of a particular update on the update service center 38. If it is inactive, the Sony® Download Taxi™ skips the file. It also confirms the location of the file and its cyclic redundancy check (CRC) value before it starts downloading the file. If the Sony® Download Taxi™ aborts abnormally (e.g., the user computer is rebooted, the user closes the program accidentally) during its next run it checks the download log in C:\Sony Support folder and continues from where it left off. While downloading a software product, the Sony® Download Taxi™ saves incremental portions (e.g., 100 kb) of the downloaded file, thus ensuring that the user does not lose more than this amount of data if the program is abnormally terminated.

Returning to FIG. 9, the interface screen also provides selectable icons that allow the user to view the downloaded installation guide and to begin the installation process of the downloaded software products. During installation, the Sony® Download Taxi™ creates a registry key in the operating systems to create a special protocol named ‘Sony Support’ and associates it with the Sony® Download Taxi™.

Other interface screens (not shown), provide selectable icons that allow the user to select from among one or more configuration states in which the device may be placed. Each configuration state is associated with one or software products that may need to be downloaded to the electronic device. The software products that are needed will depend in part on the software products currently residing on the electronic device. That is, the necessary software products will depend in part on the current configuration state of the electronic device.

It should be noted that the present invention is generally applicable to a situation in which the user makes the initial contact with the update service center 38 and determines the software products that are desired. That is, the user pulls the software products from the update service center 38. In some cases, however, the present invention may be applicable to a situation in which the update service center 38 inventories the software installed on the user computer 34, identifies additional software that may be appropriate for the user computer and makes the identified software available to the user computer 34.

As used in this application, the terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

1. A method that provides software products for installation on a user terminal, comprising:
receiving over a communications network a user selection from among a plurality of options that each specify a configuration state in which the user terminal can be placed;
and
downloading the one or more software products over the communications network to the user terminal.

2. The method of claim 1 wherein a first option specifies a configuration state that updates one or more software products currently residing on the user terminal.

3. The method of claim 1 wherein a second option specifies a previous configuration state of the user terminal.

4. The method of claim 3 wherein the previous configuration state includes one or more previously installed drivers.

5. The method of claim 3 wherein the previous configuration state includes an original configuration state of the user terminal.

6. The method of claim 1 wherein a third option specifies a configuration state that migrates the user terminal from a current operating system to a different operating system.

7. The method of claim 1 wherein at least one of the downloaded software products is configured to be automatically installed on the user terminal.

8. The method of claim 1 further comprising assembling and downloading to the user terminal an installation guide that includes installation instructions associated with each of the downloaded software products that do not install automatically.

9. The method of claim 1, wherein a request to begin downloading the one or more software products is received from a dedicated user update application, wherein the user update application is associated with an update service center that receives the request, and wherein the user update application resides on the user terminal.

10. The method of claim 8 wherein the user selection includes a selected language preference selected from a plurality of available language preferences for the installation guide.

11. The method of claim 1 further comprising receiving a request to pause the download of the one or more software products until a later time.

12. The method of claim 1 further comprising transmitting over the communications network an identification of the individual software products to be downloaded and installed on the user terminal.

13. The method of claim 1 further comprising transmitting a query over the communication network to determine if a dedicated user application associated with the update service center is installed on the user terminal and downloading the user application if it has not been previously installed on the user terminal.

14. A computer-readable medium which, when executed by one or more processors in an electronic device, performs a method for providing software products to download for installation on a remote user terminal, comprising:
receiving over a communications network a user selection from among a plurality of options that each specify a configuration state in which the user terminal can be placed;
discovering a current configuration state of the user terminal over the communications network;
based on the user selection and the current configuration state of the user terminal, identifying one or more software products needed to place the user terminal into the specified configuration state; and
downloading the one or more software products over the communications network to the user terminal.

15. A software update application, comprising:
an interface software module that initiates, establishes, and terminates communication over a communication network with a user terminal;
a receiving software module that receives over the communications network a user selection that includes a choice from among one or more options that specifies a configuration state in which the user terminal can be placed;
an auto-discovery module that discovers a current configuration state of the user terminal over the communications network;
a software identification module that identifies and accesses one or more software products needed to place the user terminal into the specified configuration state; and
a downloading software module that downloads the one or more software products to the user terminal over the communications network.

16. The software update application of claim 15 further comprising an assembling software module that assembles an installation guide in response to receipt of the user selection, said installation guide including installation instructions associated with each of the user-selected software products to be downloaded.

17. The software update application of claim 16 wherein the downloading software module downloads to the user terminal the installation guide associated the software products to be downloaded.

18. The software update application of claim 15 wherein a first option specifies a configuration state that updates one or more software products currently residing on the user terminal.

19. The software update application of claim 15 wherein a second option specifies a previous configuration state of the user terminal.

20. The software update application of claim 19 wherein the previous configuration state includes an original configuration state of the user terminal.
